(19) United States
(12) Patent Application Publication
(10) Pub. No.: US 2022/0074769 A1
(43) Pub. Date: Mar. 10, 2022

(54) MAGNETIC INDUCTIVE FLOW SENSOR AND MEASUREMENT POINT

(71) Applicant: Endress+Hauser Flowtec AG, Reinach (CH)

(72) Inventors: Heinz Rufer, Dornach (CH); Frank Voigt, Weil am Rhein (DE); Steffen Ziegler, Schopfheim (DE)

(21) Appl. No.: 17/415,844

(22) PCT Filed: Nov. 21, 2019
(86) PCT No.: PCT/EP2019/082013

§ 371 Date: Jun. 18, 2021

(30) Foreign Application Priority Data
Dec. 19, 2018 (DE) 10 2018 132 885.0

(51) Int. Cl. G01F 1/58; G01P 5/08; G01F 1/60

(52) U.S. Cl. CPC G01F 1/588; G01F 1/60; G01P 5/08

(57) ABSTRACT

The present disclosure relates to a magnetic inductive flow sensor for determining the flow or the flow speed of a liquid medium in a measurement tube and comprises a housing, a front part which is situated in the end of the housing and has a front end which can be loaded by the medium, at least two measuring electrodes which form a galvanic contact with the medium, and a magnetic-field-generating device situated in the housing for generating a magnetic field extending through the front end. The sensor for determining a process parameter of the medium is situated in the housing.

Magnetic inductive flow meters are used for determining the flow speed and/or the volume flow of a medium in a measurement tube. A magnetic inductive flow sensor comprises a magnetic-field-generating device that generates a magnetic field perpendicular to the transverse axis of the measurement tube. Single or multiple coils are typically used for this purpose. In order to realize a predominantly homogeneous magnetic field, pole shoes are additionally shaped and mounted in such a manner that an axis of symmetry of the magnetic field lines extends substantially perpendicularly to the transverse axis. A pair of measuring electrodes mounted on the lateral surface of the measurement tube taps an inductively generated electrical measuring voltage, which arises if a conductive medium flows in the direction of the longitudinal axis when the magnetic field is applied. Since, according to Faraday's law of induction, the tapped measuring voltage depends on the speed of the flowing medium, the flow speed and, with the aid of a known tube cross-section, the volume flow of the medium can be determined from the measuring voltage.

In contrast to magnetic inductive flow meters, in which a coil arrangement for generating a magnetic field penetrating a measurement tube is fixed on the lateral surface of the measurement tube and at least two measuring electrodes are situated in the inner wall, magnetic inductive flow sensors are inserted with their typically circular cylindrical housing into a lateral opening of the measurement tube and fixed in a fluid-tight manner. The mentioned coil arrangement on the lateral surface of the measurement tube is dispensed with since the magnetic field only exists in the region of the front end of the flow sensor projecting into the medium or is generated by a current flowing through its coil arrangement in such region. The flow sensor typically comprises two pin-shaped measuring electrodes. However, EP0534003A1 also discloses flow sensors having a pin-shaped measuring electrode situated in the center of the front end and a ring electrode surrounding the pin-shaped measuring electrode.

EP0892251A1 discloses a magnetic inductive flow sensor, whose front end projecting into the medium takes the form of a spherical cap and in which a first and a second galvanic electrode are situated on one of the meridians of the spherical cap in a manner symmetrical to an apex of the meridian. The flow sensor is to be immersed practically perpendicularly to a longitudinal axis of the conduit and is to be aligned by rotation in such a manner that a line connecting the two electrodes extends perpendicularly to the direction of flow.

A filling level monitoring system with an electrode for monitoring the filling level of a flowing medium in a tube is known from DE102012109308A1, which electrode has an integrated temperature sensor so that, in addition to the flow volume, the flow speed and the filling level, the temperature of the medium can also be monitored.

EP0770855A1 already discloses a magnetic inductive flow meter that, in addition to the measuring electrodes for determining a flow speed, has two pressure transducers that are situated in the wall of the measurement tube along a surface line.

U.S. Pat. No. 5,670,724 teaches a flow meter having a pair of measuring electrodes and a pressure transducer situated directly between the two measuring electrodes.

However, such embodiments are disadvantageous in that an additional opening has to be incorporated into the measurement tube for the installation of the pressure transducer and/or of the temperature sensor at the measurement point. However, each opening is a potential leakage point and should thus be avoided as much as possible.

The invention is based on the object of providing a magnetic inductive flow sensor, which is configured to determine an additional process parameter of the medium in addition to the flow volume and/or the flow speed.

The task is achieved by the flow sensor according to claim 1 and the measurement point according to claim 8.

The magnetic inductive flow sensor according to the invention for determining the flow volume and/or the flow speed of a liquid medium in a measurement tube comprises a housing, a front part situated in the end of the housing and having a front end, wherein the front end can be loaded by the medium, at least two measuring electrodes forming a galvanic contact with the medium and a magnetic-field-generating device situated in the housing for generating a magnetic field extending through the front end, and is characterized in that at least one sensor for determining a process parameter of the medium is situated in the housing.

It is particularly advantageous if at least one sensor is installed in the housing of the magnetic inductive flow sensor. For this purpose, the magnetic-field-generating device and the front part are adapted in such a manner that the sensor can be accommodated in the interior of the housing, without having to increase the outer diameter of the commercially available housing. By integrating the sensor into the housing of the flow sensor, no further opening in the conduit is required. The housing of the magnetic inductive flow sensor is typically designed to be circular-cylindrical, as a result of which it can easily be introduced into a laterally mounted opening of an existing conduit.

A sensor for determining a process parameter of the medium comprises a filling level meter, pressure transducer, temperature sensor, pH sensor, density sensor and/or viscometer.

In accordance with one embodiment, the sensor comprises a pressure transducer and/or a temperature sensor, wherein the pressure acting on the front end can be applied to the pressure transducer, wherein the temperature sensor is configured to determine a measurement signal dependent on the medium temperature.

The temperature sensor comprises a semiconductor temperature sensor, a thermocouple, a quartz oscillator temperature sensor, a pyroelectric temperature sensor, a pyrometer or a fiber optic temperature sensor.

The pressure transducer can be designed arbitrarily. The pressure transducer can be designed, for example, as a strain gauge, piezoresistive pressure sensor, piezoelectric pressure sensor, capacitive pressure sensor, inductive pressure sensor, optical pressure sensor, thermal pressure sensor or Hall pressure sensor.

In accordance with one embodiment, the front end of the pressure transducer projects from the front end of the front part. The medium flowing to the front end also contacts the pressure transducer. Alternatively, the front part has a recess into which the pressure transducer is inserted in such a manner that the front end of the pressure transducer is sunk in the recess. In both cases, the medium pressure acts directly on the pressure transducer, without it having to be conducted through a differential pressure channel to the pressure transducer.

In accordance with another embodiment, the pressure transducer is integrated in the housing and separated from the interior of the conduit by an intermediate part, a differential pressure channel or air inclusions.

The temperature sensor is configured to determine a measurement signal dependent on the medium temperature. For this purpose, it is advantageous if the temperature sensor contacts the medium.

In accordance with an alternative embodiment, the temperature sensor does not contact the medium but rather is in contact with the front part or with the housing and thus determines the measurement signal dependent on the medium temperature. Therefore, the part of the front part with which the temperature sensor is in contact is ideally made of a material having sufficiently good thermal conductivity.

In accordance with one embodiment, two sensors are situated in the housing. It is particularly advantageous if two sensors, especially, the pressure transducer and the temperature sensor, are accommodated in the housing. This makes it possible to dispense with the incorporation of additional openings into the conduit. In accordance with one embodiment, a disk with at least one differential pressure channel is situated between the pressure transducer and the front end.

It is particularly advantageous if a disk having at least one differential pressure channel is inserted between the pressure transducer and the front end of the flow sensor. The medium can thereby be conducted in a manner centered onto the pressure transducer, for example a measuring membrane. Furthermore, the pressure transducer is thereby not directly exposed to the medium at the front end. The disk advantageously decouples the pressure transducer from the medium so that pressure fluctuations in the medium are absorbed by the disk before they reach the pressure transducer.

The connection of the pressure transducer is ideally situated in the interior of the housing, where it is connected to the measuring and/or evaluating unit.

In accordance with one embodiment, the front part has at least a first and a second opening for the measuring electrodes and a third opening for the temperature sensor.

It is advantageous if the front part has an opening for the temperature sensor so that the temperature sensor can be attached in a fluid-tight manner in the front part and has direct contact with the medium. The connection of the temperature sensor is ideally situated in the interior of the housing, where it is connected to the measuring and/or evaluating unit.

In accordance with one embodiment, the front part has at least one, preferably three, openings, each designed as a differential pressure channel.

It is particularly advantageous if the front part has at least one and preferably three openings, each designed as a differential pressure channel, and thus conducts the medium to the pressure transducer situated in the housing. As a result, the pressure transducer is not in direct contact with the medium at the front end. The diameter of the openings is advantageously adapted in such a manner that particles from the medium are prevented from reaching the pressure transducer or damaging the pressure transducer or parts of the pressure transducer. This is particularly advantageous in the drinking water sector since damage to, for example, the measuring membrane and penetration of, for example, oil from the piezoresistive pressure transducer can thus be prevented.

In accordance with one embodiment, the pressure transducer comprises a printed circuit board with connections for the temperature sensor and/or the pressure transducer and at least the measuring electrodes, wherein the printed circuit board is connected to a measuring and evaluating unit.

It is particularly advantageous if the printed circuit board has a serial data bus, especially, an I²C data bus, and is subordinate to the I²C protocol. As a result, the measuring electrodes, the temperature sensor and/or the pressure transducer can be connected to the measuring and/or evaluating unit in a simple and cost-effective manner via the data bus.

A measurement point according to the invention for determining the flow of a medium comprises a conduit with a wall for guiding the medium and an opening in the wall and is characterized in that a flow sensor according to one of the preceding claims is inserted through the opening into the conduit.

The invention is explained in greater detail with reference to the following figures. The following are shown:

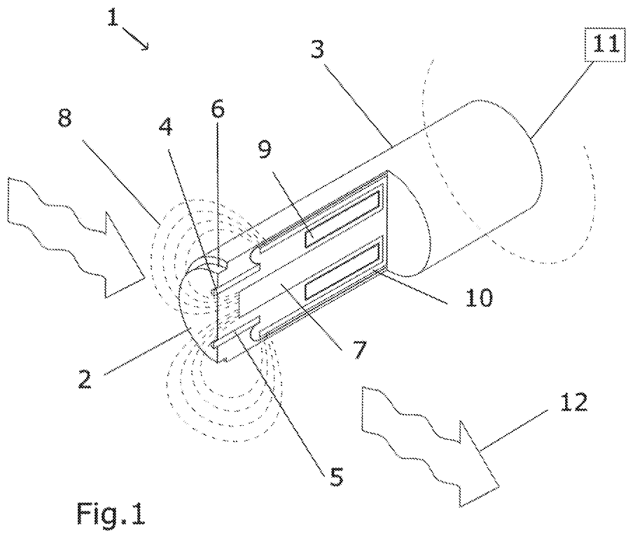

FIG. 1: a schematic perspective view of a magnetic inductive flow sensor according to the prior art;

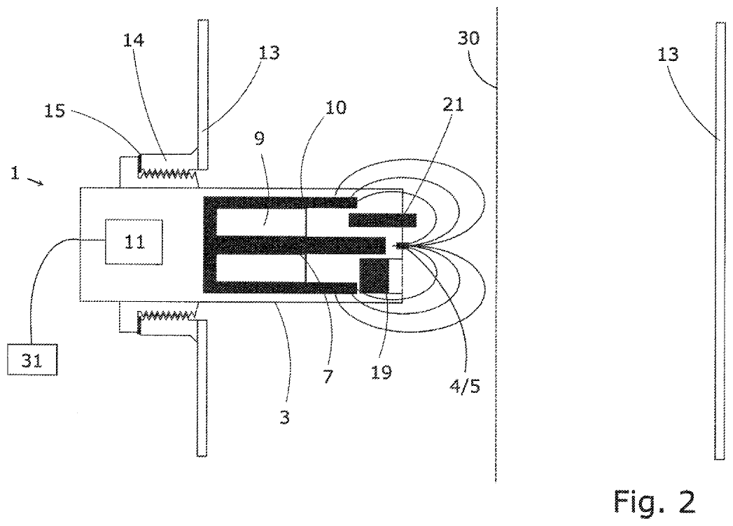

FIG. 2: a longitudinal section of a first embodiment of the magnetic inductive flow sensor according to the invention in a measurement point;

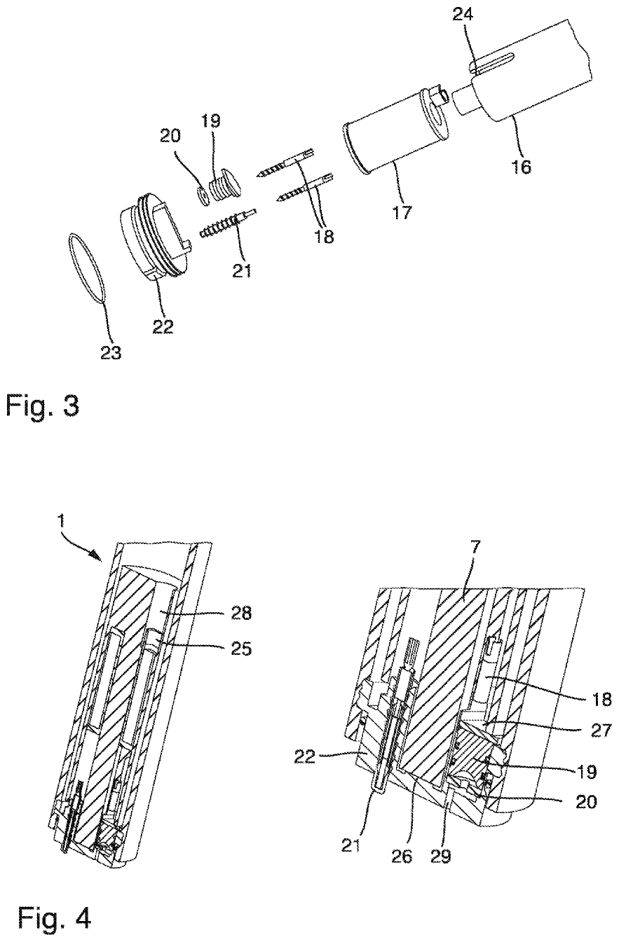

FIG. 3: an exploded view of an embodiment of the magnetic inductive flow sensor according to the invention; and

FIG. 4: an overview and a close-up view of a longitudinal section of an embodiment of the magnetic inductive flow sensor according to the invention.

The measuring principle on which the invention is based is first explained on the basis of the perspective and partially cut illustration of FIG. 1. A flow sensor (1) comprises a generally circular cylindrical housing (3) having a predetermined outer diameter. Said housing is adapted to the diameter of a bore, which is situated in a wall of a conduit (13) that is not shown in FIG. 1 but is shown in FIG. 2, and into which the flow sensor (1) is inserted in a fluid-tight manner. A medium to be measured flows in the conduit (13) and the flow sensor (1) is immersed into said medium practically perpendicularly to the direction of flow of the medium, which is indicated by the wavy arrows (12). A front end (2) of the housing (3) that projects into the medium is sealed in a fluid-tight manner with a front part (6) made of insulating material. By means of a coil arrangement (9) situated in the housing (2), a magnetic field (8) can be generated, which extends through the front end into the medium. A coil core (7), which is at least partially made of a soft magnetic material and is situated in the housing (2), terminates at or near the front end. A return (10) that surrounds the coil arrangement (9) and the coil core (7) is configured to return, into the housing (2), the magnetic field (8) extending through from the front end. The coil core (7), the coil arrangement (9) and a return (10) form a magnetic-field-generating device. A first and a second galvanic measuring electrode (4, 5) are situated in the front part (6) and contact the medium. An electrical voltage induced on the basis of the Faraday's law of induction can be tapped at the measuring electrodes (4, 5) by means of a measuring and/or evaluating unit (11). This is at a maximum if the flow sensor is installed in the conduit (13) in such a manner that a plane spanned by a straight line intersecting the two measuring electrodes (4, 5) and by a longitudinal axis of the flow sensor extends in a manner perpendicular to the direction of flow (12) or longitudinal axis of the conduit (21).

FIG. 2 shows an embodiment of the flow measurement point in longitudinal section. The flow sensor (1) is attached in the conduit (13) in a fluid-tight manner by means of a screw-in connection (14), which is inserted into the wall of the conduit (13) and is welded thereto, for example. Such structure of the measurement point is particularly suitable since the screw-in connection (14) can initially be inserted into the conduit (13) and attached therein and only then does the flow sensor (1) have to be inserted or screwed into the screw-in connection (14), in turn fixed therein and sealed by means of a seal (15). The two measuring electrodes (4, 5) are situated diametrically on the front end (2). The flow sensor is to be inserted into the conduit (13) in such a manner that a longitudinal plane, which is formed by a straight line connecting the measuring electrodes (4, 5) and the normal vector of the front end (2), intersects the longitudinal axis (30) of the conduit (13) perpendicularly. A temperature sensor (21) projects through the front end (2) into the interior of the conduit (13) and contacts the medium. The temperature sensor (21) is of pin-shaped design and is situated in the exposed space between the coil core (7) and the return (10). A pressure transducer (19) is situated in the interior of the housing (3). The medium is guided to the pressure transducer (19) through openings in the front end (2) that are designed as differential pressure channels, where the medium pressure is applied to said pressure transducer. The pressure transducer (19) is situated in the housing (3) between the coil core (7) and the housing wall. A measuring and/or evaluating unit (11) is configured to detect the individual process parameters and to forward them to a display unit (31). The measuring and/or evaluating unit (11) can be situated in the housing (3) as illustrated in FIG. 2 or externally.

FIG. 3 shows an exploded view of an embodiment of the magnetic inductive flow sensor (1) according to the invention with a temperature sensor (21) and a pressure transducer (19). The embodiment comprises a coil core with a return (7), wherein a slot is incorporated into the return (10) for leading through the connecting cables, not shown here, between the magnetic-field-generating device and the inner wall of the housing (3) along the measuring and/or evaluating unit (11). The measuring electrodes (18) are of pin-shaped design and are fluted or have ring-shaped bulges, as a result of which they can be fixed in a fluid-tight manner in the front part (22). The temperature sensor (21), here depicted in the form of a dipping sleeve, has a thread, especially, ring-shaped bulges, or is of fluted design and as a result can be situated in a fluid-tight manner in the molded part. The pressure transducer (19), especially, the pressure transducer housing, has two indentations for guiding a sealing ring in each case. Moreover, a circuit board (27) for signal conditioning is mounted on the rear side of the pressure transducer housing, to which the connecting cables of the measuring electrodes and of the temperature sensor are brought together. A disk (20) with a differential pressure channel in the form of an opening is introduced between the front end (26) of the front part (22) and the front end of the pressure transducer (19). The front part (22) has openings for the measuring electrodes (18) and the temperature sensor (21), and furthermore a recess for inserting the pressure transducer (19) into the front part (22). Indentations in the side surfaces of the front part (22) serve to fix the front part (22) in the housing (3). A seal (23) inserted in a recess in the front part (22) seals the front part (22) and the housing (3) against the medium flowing in the conduit (13). Furthermore, the front part (22) has openings (29) that are designed as a differential pressure channel for guiding the medium to the pressure transducer (19).

FIG. 4 shows an overview of a composite magnetic inductive flow sensor (1). The cables that connect the measuring electrodes (4, 5), the temperature sensor (21) and the pressure transducer (19) to the data bus applied to the circuit board (27) are not depicted. The circuit board (27) for signal conditioning communicates with the measuring and/or evaluating unit. The cables for connecting the coil device to the operating unit are also not depicted. What the overview shows but the close-up view does not depict is the connection opening (28) in the magnetic-field-generating device or in the coil core, through which the line for connecting the coil device to the operating unit is guided. The coil device furthermore has a coil connection (25), which is shaped in such a manner that the coil device is mechanically fixed with the coil core by inserting the coil connection (25) into the connection opening (28). In this embodiment, the coil core has a first part with a first cross-section and a second part with a second cross-section, wherein the cross-section of the second part is larger than the cross-section of the first part. The first part is perpendicular to the second part. Both parts are designed to be cylindrical and in this case are connected to one another in one piece. The coil device surrounds the first part and rests on the second part. Furthermore, the second part is connected in one piece to a hollow-cylindrical return. The connection opening (28) is incorporated in the second part.

The close-up view shows two recesses in the front part (22). A first recess serves as a socket for the pressure transducer (19). A second, circular cylindrical recess serves as a socket for the coil core and is designed to guide and hold in a positive-locking manner the first part of the circular cylindrical coil core. For this purpose, the diameter of the recess is adapted to the diameter of the first part of the coil core (7). As a result, the end of the coil core terminates at or near the front end (26) and the magnetic field lines exiting the front end (26) extend or the axis of symmetry of the magnetic field lines extends substantially perpendicularly through the front end (26).

### LIST OF REFERENCE SIGNS

1 Flow sensor
2 Front end
3 Housing
4 First measuring electrode
5 Second measuring electrode
6 Front part
7 Coil core
8 Magnetic field lines
9 Coil arrangement
10 Return
11 Measuring, operating and/or evaluating unit
12 Direction of flow
13 Conduit
14 Screw-in connection
15 Seal
16 Coil core with return
17 Coil device
18 Measuring electrode
19 Pressure transducer
20 Disk
21 Temperature sensor
22 Front part
23 Seal
24 Slot
25 Coil connection
26 Front end
27 Circuit board
28 Connection opening
29 Opening
30 Longitudinal axis
31 Display unit

1-8. (canceled)

9. A magnetic inductive flow sensor for determining the flow volume or the flow speed of a liquid medium in a measurement tube, including:
a housing;
a front part situated in the end of the housing and having a front end,
wherein the front end can be loaded by the medium;
at least two measuring electrodes forming a galvanic contact with the medium; and
a magnetic-field-generating device situated in the housing for generating a magnetic field extending through the front end;
wherein in that at least one sensor for determining a process parameter of the medium is situated in the housing.

10. The flow sensor of claim 9,
wherein the sensor comprises a pressure transducer or a temperature sensor,
wherein the pressure acting on the front end can be applied to the pressure transducer,
wherein the temperature sensor is configured to determine a measurement signal dependent on the medium temperature.

11. The flow sensor of claim 9,
wherein two sensors are situated in the housing.

12. The flow sensor of claim 10,
wherein a disk having at least one differential pressure channel is situated between the pressure transducer and the front end.

13. The flow sensor of claim 12,
wherein the front part has at least a first and a second opening for the measuring electrodes and a third opening for the temperature sensor.

14. The flow sensor of claim 9,
wherein the front part has at least a first and a second opening for the measuring electrodes and at least one opening, each designed as a differential pressure channel.

15. The flow sensor of claim 9,
wherein the pressure transducer comprises a printed circuit board with connections for the temperature sensor or the pressure transducer and at least the measuring electrodes,
wherein the printed circuit board is connected to a measuring and evaluating unit.

16. A measurement point for determining a flow volume or a flow speed of a medium, including:
a conduit having a wall for guiding the medium; and
an opening in the wall;
wherein a flow sensor is inserted through the opening into the conduit;
wherein the flow sensor includes:
a housing;
a front part situated in the end of the housing and having a front end,
wherein the front end can be loaded by the medium;
at least two measuring electrodes forming a galvanic contact with the medium; and
a magnetic-field-generating device situated in the housing for generating a magnetic field extending through the front end;
wherein in that at least one sensor for determining a process parameter of the medium is situated in the housing.
